(19) United States
(12) Patent Application Publication
(10) Pub. No.: US 2023/0239523 A1
(43) Pub. Date: Jul. 27, 2023

(54) DYNAMIC VISUAL INTENSITY RENDERING

(71) Applicant: SoClip!, Bandol (FR)

(72) Inventor: Christophe Vaucher, Bandol (FR)

(21) Appl. No.: 18/159,939

(22) Filed: Jan. 26, 2023

Related U.S. Application Data
(60) Provisional application No. 63/303,791, filed on Jan. 27, 2022.

(51) Int. Cl. H04N 21/242; H04N 21/43

(52) U.S. Cl. CPC H04N 21/242; H04N 21/4307

(57) ABSTRACT

The present technology can provide a mechanism for adjusting a visual effect that is associated with an audio artifact at a given frequency bandwidth that is attenuated by speaker characteristics. The intensity of the visual effects that is adjusted can also be attributed to a change in volume settings of a processing device as well as an intensity of a multimedia skin in which the visual effect is encoded. The multimedia skin includes filters, transitions/animations, and/or image universal processing, that can be applied to any set of photos, videos, and/or songs, in order to create, in real-time, many variations of the same digital multimedia file, wherein each multimedia skin leads to a specific video rendering.

### CROSS-REFERENCE TO RELATED APPLICATION

This application claims priority to U.S. Provisional Application No. 63/303,791 filed Jan. 27, 2022, which is incorporated by reference herein in its entirety.

### FIELD

The present technology generally relates to a method for audio-visual synchronization, and in particular, for dynamically rendering visual effects based on an audio channel frequency output.

### BRIEF DESCRIPTION OF THE DRAWINGS

FIG. 1 illustrates an example diagram 100 showing audio-visual synchronization for dynamically rendering visual effects delivered on a smartphone speaker, according to some aspects of the disclosed technology.

FIG. 2 illustrates an example diagram 200 showing audio-visual synchronization for dynamically rendering visual effects delivered on a non-smartphone speaker, according to some aspects of the disclosed technology.

FIG. 3 illustrates an example diagram 300 showing audio-visual synchronization for dynamically rendering visual effects delivered on a smartphone speaker at 70% volume, according to some aspects of the disclosed technology.

FIG. 4 illustrates an example diagram 400 showing audio-visual synchronization for dynamically rendering visual effects delivered on a non-smartphone speaker at 70% volume, according to some aspects of the disclosed technology.

FIG. 5 illustrates an example diagram 500 showing the components of a multimedia skin that may be applied to the digital multimedia file, according to some aspects of the disclosed technology.

FIG. 6 illustrates an example diagram 600 showing graphs that map and contribute to an overall function for determining an intensity parameter for visual effects, according to some aspects of this disclosure.

FIG. 7 illustrates steps of an example process for adjusting an intensity of a visual effect that is timed to an audio artifact at a given frequency bandwidth that is attenuated by speaker characteristics, according to some aspects of the disclosed technology.

FIG. 8 illustrates an example processor-based system with which some aspects of the subject technology can be implemented.

### DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

Aspects of the disclosed technology provide solutions to adjust a visual effect that is timed to an audio artifact at a given frequency bandwidth that is attenuated by speaker characteristics. For example, low frequencies are not heard at their intended volume through some smartphone speakers, such as those attributed to kick hits in musical compositions. As such, such kick hits are not well-rendered due to some speaker characteristics. As a result, audio effects that are tied to match the timing of such kick hits may appear to be synced improperly and diminish the intended effect seamless matching of certain audio qualities with visual effects.

In some implementations, the disclosed technology also can discern between uses of different kinds of speakers, such as a distinction between a smartphone speaker versus a non-smartphone speaker, such as a hard-wired/wired or Bluetooth headset. For most wired or Bluetooth headsets, the lower frequencies are heard at their intended volume and therefore the intensity of the visual effect should match without attenuation. As such, based on the set volume and what kind of speaker or a Bluetooth device the audio is delivered at, an effect intensity parameter may be determined and applied to the corresponding visual effect. In some aspects, hard-wired/wired (jack, micro-jack, USB, Lightening®, . . . ) devices may include wired headsets and wired speakers. In some aspects, wirelessly-connected audio outputs may include BLUETOOTH®, AIRPLAY®, CHROMECAST®, or any other wirelessly-connected audio output. Depending on the kind of wirelessly-connected audio output, the processing application, such as via an SDK, may elect for a particular smart intensity curve for determining intensity changes for visual effects.

Additional details regarding processes for analyzing and identifying audio artifacts in a musical composition (e.g., an audio file) are discussed in relation to U.S. application Ser. No. 16/503,379, entitled “BEAT DECOMPOSITION TO FACILITATE AUTOMATIC VIDEO EDITING,” and to U.S. application Ser. No. 17/345,966, entitled “AUTOMATED AUDIO-VIDEO CONTENT GENERATION,” which is herein incorporated by reference in its entirety. As discussed in further detail below, aspects of the technology can be implemented using an API and/or a software development kit (SDK) that are configured to automatically set an offset based on experienced audiovisual latency, which may be determined by settings and conditions associated with playback of an audiovisual content.

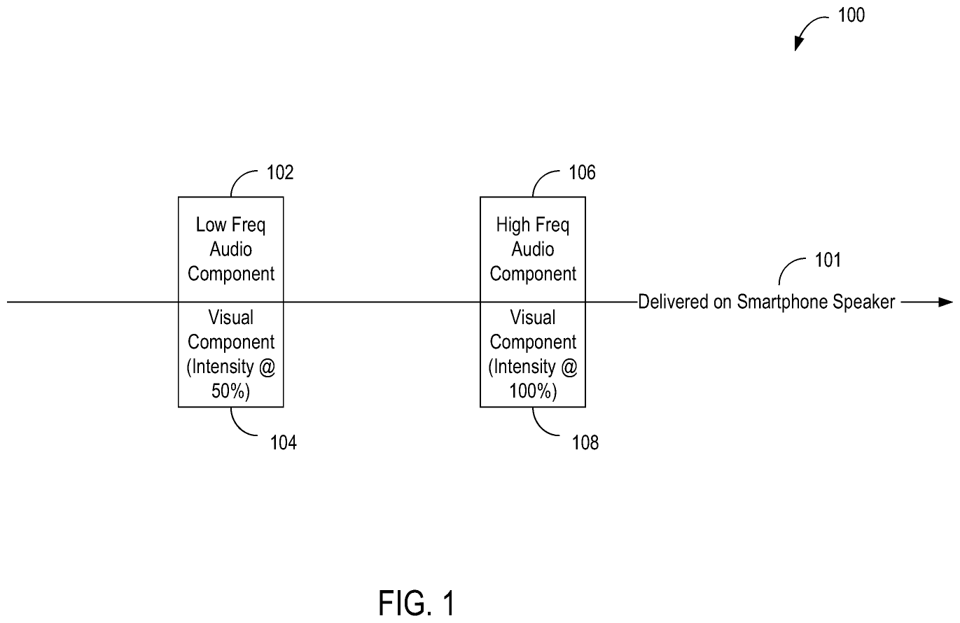

FIG. 1 illustrates an example diagram 100 showing audio-visual synchronization for dynamically rendering visual effects delivered on a smartphone speaker, according to some aspects of the disclosed technology. More specifically, FIG. 1 the example diagram 100 shows that a low-frequency audio component 102 timed to a first visual effects component 104 and a high-frequency audio component 106 timed to a second visual effects component 108 of a digital multimedia file with audio being delivered at a smartphone speaker 101. By way of example, the digital multimedia file may include MP3, MP4, or WAV encoded content. Based on the determination that the audio is being delivered on a smartphone speaker, the first visual effects component 104 associated with the low-frequency audio component 102 is generated at a lower intensity, of 50% for example. For example, if the first visual component 104 vibrates a synced lyrical phase, the intensity of the vibration would be reduced proportionally to how the channel frequency (KHz) is reduced due to the properties of the smartphone speaker.

As such, depending on the speaker, some may deliver lower frequencies at different intensities. Smart volume curves that map out the idiosyncrasies of how particular frequencies are delivered by particular kinds of speakers may be used to calculate an accurate intensity reduction of the visual effects components.

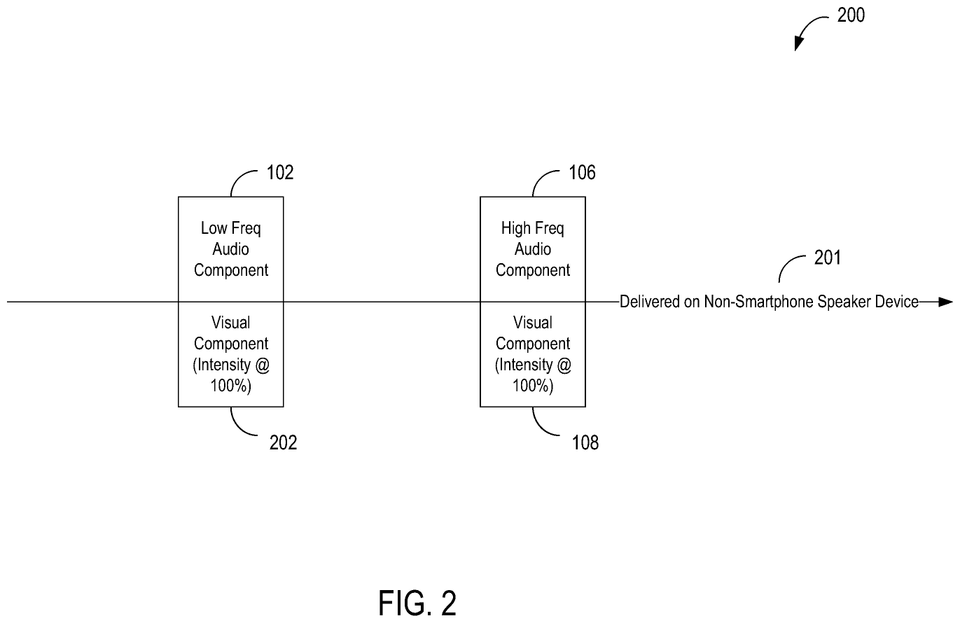

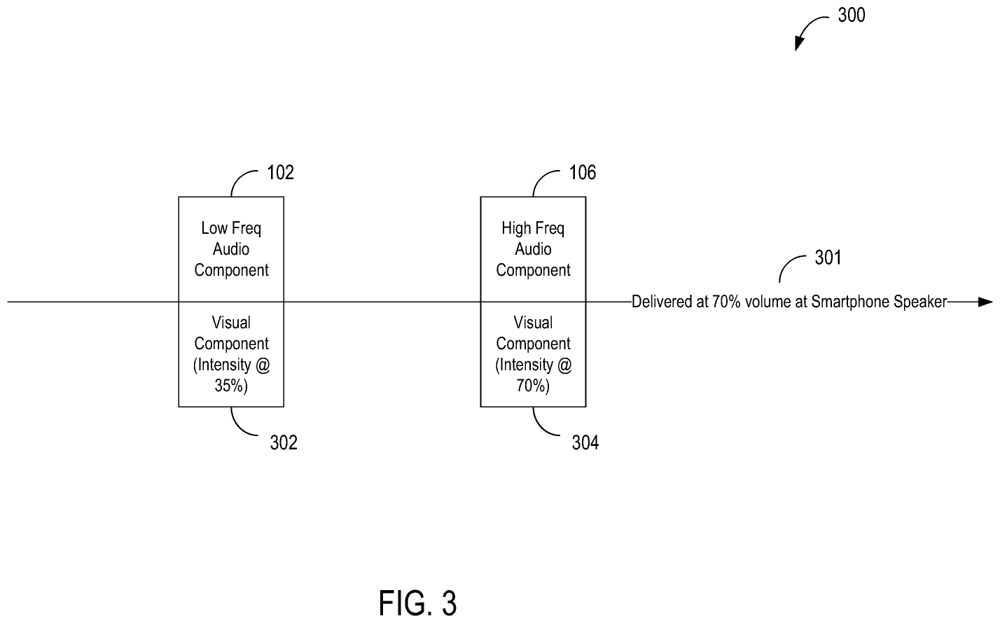

FIG. 2 illustrates an example diagram 200 showing audio-visual synchronization for dynamically rendering visual effects delivered on a non-smartphone speaker, according to some aspects of the disclosed technology. More specifically, the example diagram 200 shows that the low-frequency audio component 102 and the high-frequency audio component 106 of the same digital multimedia file with a dynamic effects layer and with audio being delivered at a Bluetooth device 201. Based on the determination that the audio is being delivered on a hard-wired device or on a Bluetooth device, instead of displaying the first visual effects component 104, a third visual effects component 202 is displayed, with an intensity of 100%. This is with an assumption that the volume being played is at a level that is at a typical factory setting or above. This is further discussed in the following paragraphs associated with FIGS. 3-5.

There may be settings that allow for changing between effects when a certain intensity threshold is reached. For example, when intensity levels are to reach below 25%, the effect may be removed and when intensity levels are between 25-50%, in following the example above, rather than vibrating the synced lyrical phase at a 25-50% intensity, a different effect may be used. For example, the synced lyrical phase may be slightly enlarged to add a more subtle effect of emphasis rather than be vibrated. Other kinds of effects may include changing the color scheme of the digital multimedia file, applying visual editing of the video, such as zooming in or adding computer-generated imagery.

FIG. 3 illustrates an example diagram 300 showing audio-visual synchronization for dynamically rendering visual effects delivered on a smartphone speaker at 70% volume, according to some aspects of the disclosed technology. More specifically, the example diagram 300 shows that the low-frequency audio component 102 and the high-frequency audio component 106 of the digital multimedia file, with audio being delivered at a smartphone speaker at 70% volume 301. Based on the determination that the audio being delivered at a smartphone speaker at 70% volume 301, a fourth visual effects component 302 associated with the low-frequency audio component 102 is generated at a lower intensity. The lowered intensity is, as illustrated in FIG. 3, even lower than that of the first visual effects component 104. This is due to the aggregative nature of (1) the fourth visual effects component 302 is associated with the low-frequency audio component 102 and delivering the audio on a smartphone speaker and (2) lowering the volume to 70%, resulting in a compounding reduction of intensity. Furthermore, based on the determination that the audio being delivered at a smartphone speaker at 70% volume 301, a fifth visual effects component 304 associated with the low-frequency audio component 102 is also generated at a lower intensity. This lowered intensity is only due to the lowering the volume to 70%.

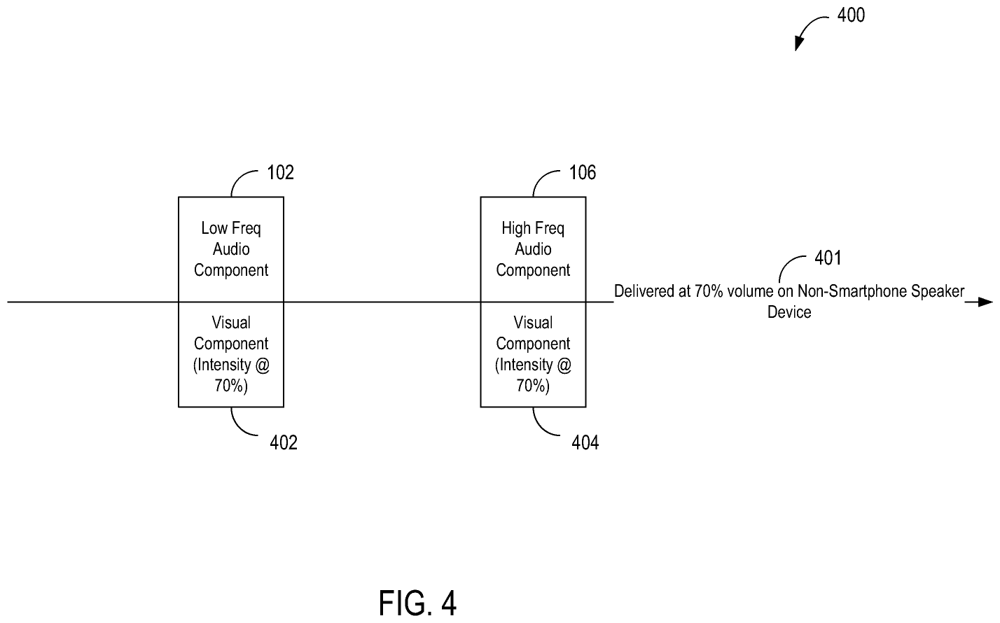

FIG. 4 illustrates an example diagram 400 showing audio-visual synchronization for dynamically rendering visual effects delivered on a non-smartphone speaker at 70% volume, according to some aspects of the disclosed technology. More specifically, the example diagram 400 shows that the low-frequency audio component 102 and the high-frequency audio component 106 of the digital multimedia file, with audio being delivered at a Bluetooth device at 70% volume 401. Based on the determination that the audio being delivered at a smartphone device at 70% volume 301, a sixth visual effects component 402 associated with the low-frequency audio component 102 is generated at a lower intensity. This lowered intensity is only due to the lowering the volume to 70%. Similarly, based on the determination that the audio being delivered at a Bluetooth device at 70% volume 401, a seventh visual effects component 404 associated with the high-frequency audio component 106 is also generated at a lower intensity.

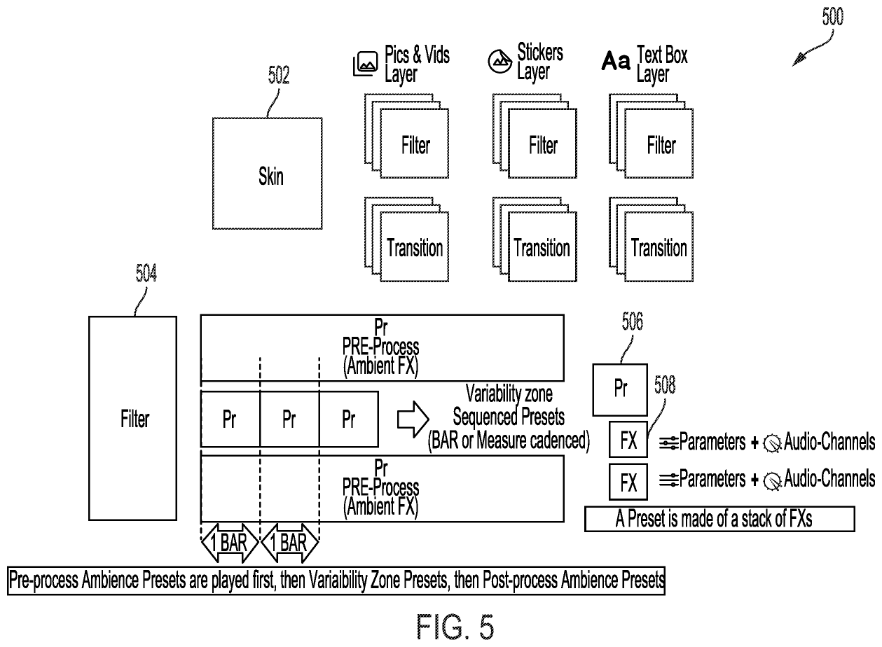

FIG. 5 illustrates an example diagram 500 showing the components of a multimedia skin that may be applied to the digital multimedia file, according to some aspects of the disclosed technology. Changing the intensity of the visual effects component may be applied as a parameter change in a skin 502. A multimedia skin 502 may include filters 502, transitions/animations, and/or image universal processing, that can be applied to any set of photos, videos, and/or songs, in order to create, in real-time, many variations of the same digital multimedia file, wherein each multimedia skin 502 leads to a specific video rendering.

In some examples, an audio file (e.g., a song, music, etc.), a media file (e.g., pictures, video, images, etc.) which excludes the audio file, and a template/strategy (referred to as the multimedia skin) for applying media effects can be used for automatically generating audio-video content, such as music video clips. The audio file may be processed to determine parameters or elements such as sections of average energy levels, transitions, beats (beats-per-minute, main beat, drum hit types, etc.), audio events level (ex: Drum Hit Intensity), and the multimedia skin may automatically apply media effects to the media file based on these parameters of the audio file to generate the audio-video file. For example, long transitions may be more applied for calm and slow music (corresponding to low energy sections) whereas shorter transitions may be more applied for fast and powerful music (corresponding to high energy or beats-per-minute sections).

The filter 504 may be a complex build-up of various sequenced presets (Pr) 506. Each preset may include one or more visual effects (Fx) component 508. Each FX may have at least one parameter that can be set up in different modes and wired to an audio channel featuring in the digital music sheet of a song, retrieved from a MP3 file.

Each visual effects component 504 may be associated with a particular audio channel that is associated with different frequencies (KHz). For example, one audio channel may be associated with kick hits, which may be used to animate and synchronize certain visual effects and adjust their intensities. Other audio channels may be associated with snare hits or other kinds of musical artifacts. Another audio channel may be associated with a local beat that is used to generate scene cuts for a media timeline. Another audio channel may be associated with a sound flow aspect that is used to adjust a variation of a sound flow visual effect. Another audio channel may be associated with a groover that is used to adjust video speed and other visual effect intensities. Another audio channel may be associated with a bar or measure and used to cadence certain visual effects.

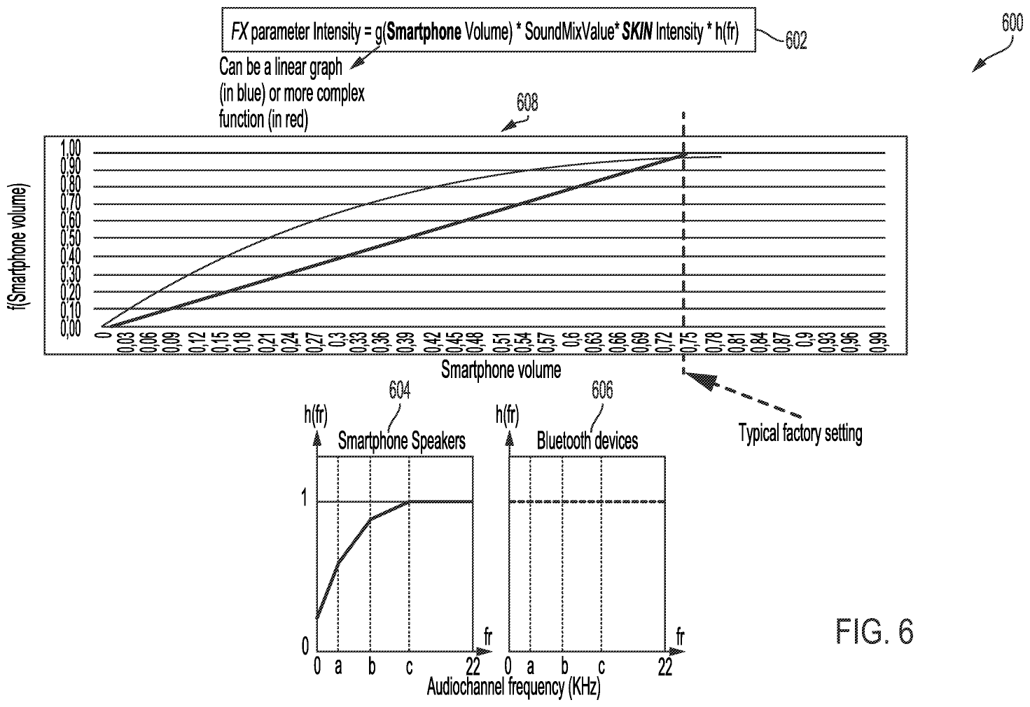

FIG. 6 illustrates an example diagram 600 showing graphs that map and contribute to an overall function for determining an intensity parameter for visual effects, according to some aspects of this disclosure. A generalized function 602 for determining an intensity parameter for visual effects may depend on a function of the level of volume being played, a sound mix value, an intensity of the multimedia skin 502, and a function of speaker performance for a range of audio channel frequencies, and differentiating between speakers and Bluetooth devices.

With respect to the sound mix value, other secondary sounds, other than the one for which the digital music sheet is attributed to, may be used as part of the audio. For example, a soundtrack of a video scene, whoosh sounds, etc. To give room for such secondary sounds, the audio for the song associated with the digital music sheet may be lower than 100%. As such, generalized function 602 incorporates the sound mix value such that the Fx parameter intensity is attenuated from such a lowered value when these secondary sounds are there.

The function of speaker performance for a range of audio channel frequencies for speakers, such as smartphone speakers, is graphed in a first example graph 604. The first example graph 604 illustrates that for lower frequencies, a and b, the outputs of the speakers are not at 1 (or 100%). As such, when such frequencies are being delivered at the smartphone speakers, visual effects that are displayed simultaneously with the same particular low-frequency audio component 106 are attenuated as opposed to those delivered at Bluetooth devices, as exemplified by a second example graph 606.

Furthermore, the correlation for smartphone speakers may not be linear as illustrated in a third example graph 608, similar to how the human ear does not perceive sounds the same intensity depending on the sound frequency and on the sound volume. For this reason, the “g” function is not necessarily a linear function. As such, information with respect to the quality of reproduction of different smartphone speakers or speakers, in general, may be collected to create smart volume curves that can map what the appropriate attenuation is for different modes of output.

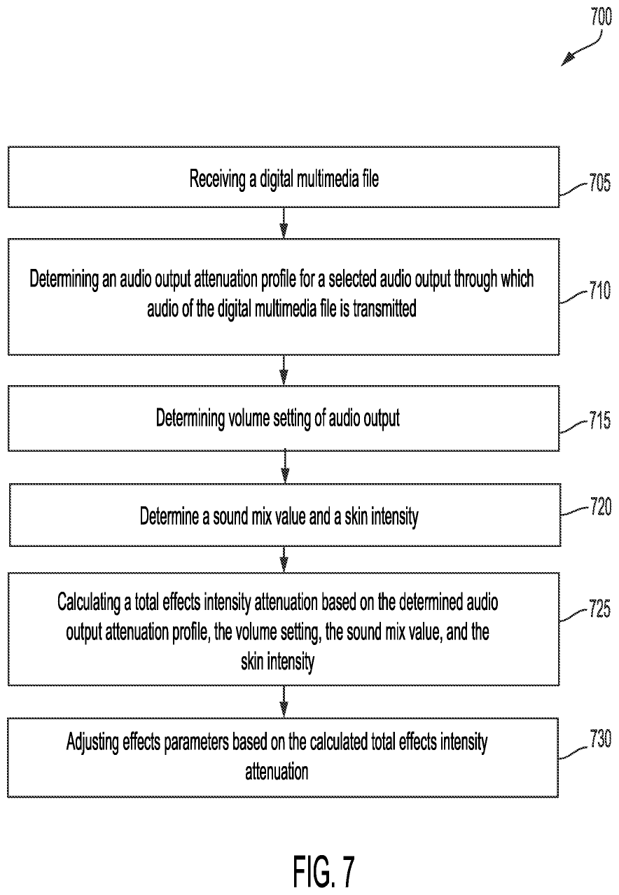

FIG. 7 illustrates steps of an example process 700 for adjusting an intensity of a visual effect that is timed to an audio artifact at a given frequency bandwidth that is attenuated by speaker characteristics, according to some aspects of the disclosed technology. Process 700 begins with step 705, wherein a digital multimedia file is received, for example, at a multimedia editing platform including playback service or at a multimedia playback platform. In some implementations, one or more still images (digital pictures) may be received in addition to one or more songs, in the form of a music video. Depending on the desired implementation, the multimedia editing or playback platform may be implemented as an application, for example, that is executed on a server, and/or executed using a number of distributed computing nodes, for example, in a cloud infrastructure. In some respects, all (or portions) of the multimedia editing or playback platform functionality may be hosted on a mobile processing device, such as a smartphone, notebook, or tablet computer, etc.

In some respects, the audio file may contain one or more songs, for example, that are intended to be synced to the visual component, a series of still images to be rendered at a certain frame rate to display a video. The intended syncing may be based on an alignment of the audio file and the video file in a timeline-based video editing software application. However, as mentioned above, post-production issues may cause the audiovisual experience to be unsynced at the human brain if not corrected.

In step 710, an audio output attenuation profile may be determined based on a selected audio output through which audio of the digital multimedia file is transmitted. For example, a determination may be made for whether a processing device, such as a smartphone device, is performing the playback is connected to a hard-wired speaker or headset, a wirelessly-connected audio output or through its internal built-in speaker system. In some aspects, hard-wired (jack, micro-jack, USB, Lightening®, . . . ) devices may include wired headsets and wired speakers. In some aspects, wirelessly-connected audio outputs may include BLUETOOTH®, AIRPLAY®, CHROMECAST®, or any other wirelessly-connected audio output. A library of audio output attenuation profiles may be stored with respect to different external audio outputs and/or kinds of internal built-in speaker systems and the different attenuations that may (or may not) occur at different frequencies.

In step 715, a volume setting of the audio output may be determined. For example, a typical factory setting of the processing device for audio may be set at typically 75% of the max volume of the smartphone (this value may vary depending on smartphone manufacturer). At factory default settings, the sound volume is in general not set to its maximum value. As this 75% value is considered as the nominal working value, the nominal intensity of visual effects is set for the nominal volume setting (and not for the max volume of the smartphone). The “g” function values (608) may be higher than 1, depending on “g”, but we recommend to keep “g” values at 1 above the factory setting of smartphone volume. Put another way, the lower the smartphone volume is set, based on the generalized function 602 for determining an intensity parameter for visual effects, the intensity of visual effects should be lowered as well.

In step 720, a sound mix value and skin intensity may be determined. The sound mix value, as described above, may attenuate the audio associated with the audio file based on whether or not there are secondary sounds. As such, the attenuated audio may cause further attenuation of the intensity of visual effects. The intensity of the multimedia skin 502 may also be adjusted by a user on their processing device, such as their smartphone.

In step 725, a total effects intensity attenuation may be calculated based on at least one of the determined audio output attenuation profile, the volume setting, the sound mix value, and the multimedia skin intensity. How each of these aspects may affect the total effects intensity attenuation may also be adjustable.

In step 730, the effects parameter associated with visual effects that are displayed in the digital multimedia file may be adjusted based on the calculated total effects intensity attenuation. The resulting displayed digital multimedia may display an attenuation visual effect associated with a musical artifact at a particular frequency that is attenuated by the internal speakers of the processing device, on which the digital multimedia is being displayed.

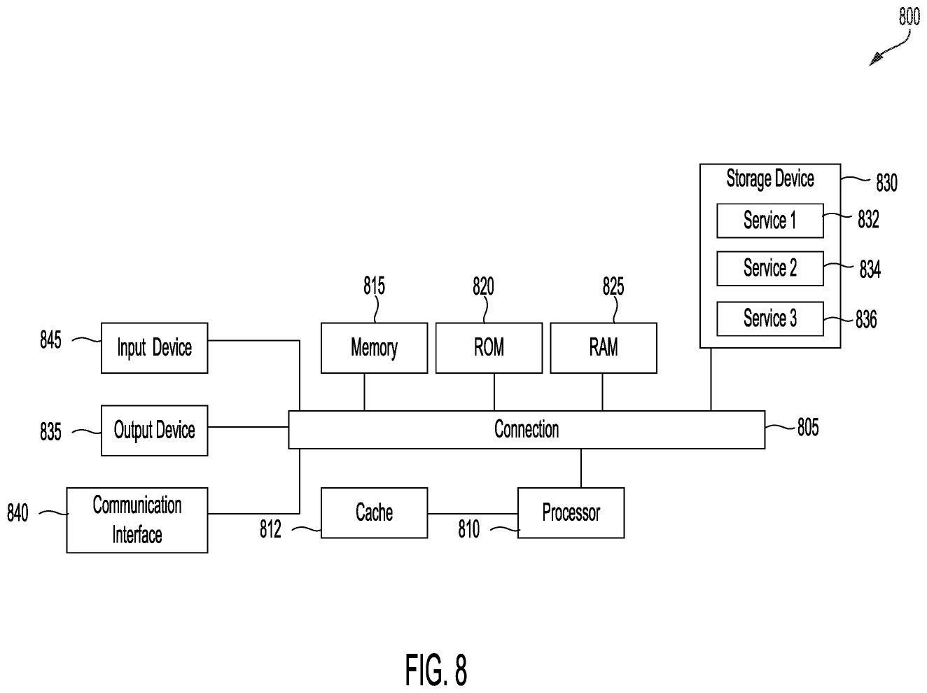

FIG. 8 illustrates an example processor-based system with which some aspects of the subject technology can be implemented. For example, processor-based system 800 that can be any computing device that is configured to generate and/or display customized video content for a user and/or which is used to implement all, or portions of, a multimedia editing/playback platform, as described herein. By way of example, system 800 can be a personal computing device, such as a smart phone, a notebook computer, or a tablet computing device, etc. Connection 805 can be a physical connection via a bus, or a direct connection into processor 810, such as in a chipset architecture. Connection 805 can also be a virtual connection, networked connection, or logical connection.

In some embodiments, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 800 includes at least one processing unit (CPU or processor) 810 and connection 805 that couples various system components including system memory 815, such as read-only memory (ROM) 820 and random-access memory (RAM) 825 to processor 810. Computing system 800 can include a cache of high-speed memory 812 connected directly with, in close proximity to, and/or integrated as part of processor 810.

Processor 810 can include any general-purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a Blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

Storage device 830 can include software services, servers, services, etc., that when the code that defines such software is executed by the processor 810, it causes the system to perform a function. In some embodiments, a hardware service that performs a particular function can include the software component stored in a computer-readable medium in connection with the necessary hardware components, such as processor 810, connection 805, output device 835, etc., to carry out the function.

By way of example, processor 810 may be configured to execute operations for automatically determining an offset based on circumstantial factors, such as protocols that are used for delivering the digital multimedia content. By way of example, processor 810 may be provisioned to execute any of the operations discussed above with respect to process 600, described in relation to FIG. 6. By way of example, processor 810 may be configured to receive a digital multimedia file. In some aspects, processor 810 may be further configured for determine whether there is a wireless audio transport playback protocol for the digital multimedia file.

In some aspects, processor 810 may be further configured for determining whether there is an encoding image latency based on whether the digital multimedia file is encoded. In some aspects, processor 810 can be further configured to calculate a total audio latency offset based on a retinal image latency in addition to the encoding image latency minus the wireless audio transport latency. In some aspects, processor 810 may be further configured to execute operations for shifting a series of still images of the digital multimedia file forward in time by the total audio latency offset.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

What is claimed is:

1. A computer-implemented method for adjusting an intensity of visual effects, comprising:
receiving, at a multimedia editing platform including a playback service or at a multimedia playback platform, a digital multimedia file;
determining an audio output attenuation profile for a selected audio output through which audio of the digital multimedia file is transmitted;
determining a volume setting of the selected audio output;
determining a sound mix value and a skin intensity;
calculating a total effects intensity attenuation based on the determined audio output attenuation profile, the volume setting, the sound mix value, and the skin intensity; and
adjusting effects parameters based on the calculated total effects intensity attenuation, wherein visual effects are timed to an audio artifact at a given frequency bandwidth that is attenuated by the calculated total effects intensity attenuation.

2. The computer-implemented method of claim 1, wherein the determining the audio output attenuation profile includes determining that a processing device is performing a playback via the playback service through a connected hard-wired speaker or headset, a wirelessly connected audio output, or its internal built-in speaker system.

3. The computer-implemented method of claim 1, further comprising:
storing a library of audio output attenuation profiles with respect to at least one of different kinds of external audio outputs, different kinds of internal built-in speaker systems, or different attenuations at different frequencies.

4. The computer-implemented method of claim 1, wherein the volume setting is at a factory setting of a processing device performing a playback via the playback service, wherein the factory setting is lower than a maximum volume of the processing device.

5. The computer-implemented method of claim 4, wherein the volume setting is a nominal working value, wherein a nominal intensity of visual effects is set for the volume setting and not for the maximum volume.

6. The computer-implemented method of claim 1, wherein the sound mix value attenuates an audio aspect of the digital multimedia file based on whether or not there are secondary sounds and, wherein the attenuated audio further causes attenuation of visual effects intensity.

7. The computer-implemented method of claim 1, further comprising:
receiving an adjustment of the skin intensity by a user on their processing device.

8. The computer-implemented method of claim 1, further comprising:
displaying the digital multimedia file with an attenuation visual effect associated with a musical artifact at a particular frequency that is attenuated by internal speakers of a processing device performing a playback via the playback service.

9. A system for adjusting an intensity of visual effects, comprising:
a storage configured to store instructions;
a processor configured to execute the instructions and cause the processor to:
receiving, at a multimedia editing platform including a playback service or at a multimedia playback platform, a digital multimedia file;
determine an audio output attenuation profile for a selected audio output through which audio of the digital multimedia file is transmitted;
determine a volume setting of the selected audio output;
determine a sound mix value and a skin intensity;
calculate a total effects intensity attenuation based on the determined audio output attenuation profile, the volume setting, the sound mix value, and the skin intensity; and
adjust effects parameters based on the calculated total effects intensity attenuation, wherein visual effects are timed to an audio artifact at a given frequency bandwidth that is attenuated by the calculated total effects intensity attenuation.

10. The system of claim 9, wherein the determining the audio output attenuation profile includes determining that a processing device is performing a playback via the playback service through a connected hard-wired speaker or headset, a wirelessly connected audio output, or its internal built-in speaker system.

11. The system of claim 9, wherein the processor is configured to execute the instructions and cause the processor to:
store a library of audio output attenuation profiles with respect to at least one of different kinds of external audio outputs, different kinds of internal built-in speaker systems, or different attenuations at different frequencies.

12. The system of claim 9, wherein the volume setting is at a factory setting of a processing device performing a playback via the playback service, wherein the factory setting is lower than a maximum volume of the processing device.

13. The system of claim 12, wherein the volume setting is a nominal working value, wherein a nominal intensity of visual effects is set for the volume setting and not for the maximum volume.

14. The system of claim 9, wherein the sound mix value attenuates an audio aspect of the digital multimedia file based on whether or not there are secondary sounds and, wherein the attenuated audio further causes attenuation of visual effects intensity.

15. The system of claim 9, wherein the processor is configured to execute the instructions and cause the processor to:
receive an adjustment of the skin intensity by a user on their processing device.

16. The system of claim 9, wherein the processor is configured to execute the instructions and cause the processor to:
display the digital multimedia file with an attenuation visual effect associated with a musical artifact at a particular frequency that is attenuated by internal speakers of a processing device performing a playback via the playback service.

17. A non-transitory computer readable medium comprising instructions, the instructions, when executed by a computing system, cause the computing system to:
receive, at a multimedia editing platform including a playback service or at a multimedia playback platform, a digital multimedia file;
determine an audio output attenuation profile for a selected audio output through which audio of the digital multimedia file is transmitted;
determine a volume setting of the selected audio output;
determine a sound mix value and a skin intensity;
calculate a total effects intensity attenuation based on the determined audio output attenuation profile, the volume setting, the sound mix value, and the skin intensity; and
adjust effects parameters based on the calculated total effects intensity attenuation, wherein visual effects are timed to an audio artifact at a given frequency bandwidth that is attenuated by the calculated total effects intensity attenuation.

18. The computer readable medium of claim 17, the determining the audio output attenuation profile includes determining that a processing device is performing a playback via the playback service through a connected hard-wired speaker or headset, a wirelessly connected audio output, or its internal built-in speaker system.

19. The computer readable medium of claim 17, wherein the computer readable medium further comprises instructions that, when executed by the computing system, cause the computing system to:
store a library of audio output attenuation profiles with respect to at least one of different kinds of external audio outputs, different kinds of internal built-in speaker systems, or different attenuations at different frequencies.

20. The computer readable medium of claim 17, the volume setting is at a factory setting of a processing device performing a playback via the playback service, wherein the factory setting is lower than a maximum volume of the processing device.
